(19) United States
(12) Patent Application Publication
(10) Pub. No.: US 2013/0328248 A1
(43) Pub. Date: Dec. 12, 2013

(54) PROCESS AND DEVICE FOR BLOW MOULDING STERILE CONTAINERS

(71) Applicants: Thomas Herold, Ahrensburg (DE); Harald Rieger, Hamburg (DE); Dieter Klatt, Hamburg (DE); Martin Gehards, Hamburg (DE)

(72) Inventors: Thomas Herold, Ahrensburg (DE); Harald Rieger, Hamburg (DE); Dieter Klatt, Hamburg (DE); Martin Gehards, Hamburg (DE)

(73) Assignee: KHS CORPOPLAST GMBH, Hamburg (DE)

(21) Appl. No.: 13/995,373

(22) PCT Filed: Nov. 14, 2011
(86) PCT No.: PCT/DE11/02016

§ 371 Date: Aug. 13, 2013

(30) Foreign Application Priority Data
Dec. 23, 2010 (DE) 10 2010 056 450.8

(51) Int. Cl. B29D 22/00

(52) U.S. Cl. CPC B29D 22/003
USPC 264/535; 425/526

(57) ABSTRACT

A method and device for producing blow-molded containers, at least some regions of which are sterile. A parsion made of thermoplastic material is first heated and then exposed to a pressurized fluid. A sterilization means is introduced into an area of the parison. Sterilization is carried out at a sterilization site a spatial distance away from a blowing unit, which shapes the parison. Instead of maintaining the entire area of the blowing device as a sterile space, the parison is transported from the sterilization site to the blowing unit at least along a portion of a transport path along a sterile channel.

The invention relates to a process for producing blow-molded containers, at least some areas of which are sterile, wherein a parison made of a thermoplastic material is first heated and then exposed to a pressurized fluid, and wherein a sterilization means is introduced into the area of the parison.

The invention further relates to a device for producing at least a blow-molded container, at least some areas of which are sterile, which comprises a feeding device for exposing at least a portion of a parison to a sterilization means, and which is provided with a heating section for bringing the parisons to the correct temperature and with a blowing device for blow molding the parisons to form the containers.

The production of sterile blow-molded containers typically occurs in such a manner that these containers are sterilized after they have been blow molded and before filling using hydrogen peroxide and other chemicals. It is also already known to sterilize the parisons used as starting product during the blow molding of the containers, particularly the area of the inner surface of these parisons.

In the blow molding of a container by exposure to the action of a blow pressure, the parisons made of a thermoplastic material, for example, parisons made of PET (polyethylene terephthalate), are fed to different processing stations within a blowing machine. Typically, such a blowing machine comprises a heating device as well as a blowing device, in whose area the previously tempered parisons are expanded biaxially to faun a container. The expansion is carried out using pressurized air that has been introduced into the parison to be expanded. The process technology of such an expansion of the parison is explained in German Patent Application DE-OS 43 40 291.

The basic design of a blowing station for blow molding containers is described in German Patent Application DE-OS 42 12 583. Possibilities for bringing the parisons to the correct temperature are described in German Patent Application DE-OS 23 52 926.

Within the device for blow molding, the parisons as well as the blow-molded containers can be transported using different handling devices. The use of transport mandrels onto which the parisons are stuck has been shown to be particularly satisfactory. However, the parisons can also be handled with other supporting devices. The use of gripping pliers for handling parisons and the use of expanding mandrels which can be introduced for the purpose of retention into an opening area of the parison are also part of the available constructions.

The handling of containers using transfer wheel is described, for example, in German Patent Application DE-OS 199 06 438, in the form of an arrangement of the transfer wheel between a blowing wheel and a discharge section.

The handling of the parisons which has already been described occurs, on the one hand, in the so-called two-step process in which the parisons are produced first in an injection molding process, are then placed in intermediate storage, and are conditioned only later with regard to their temperature, and blown out to form a container. In the so-called one-step processes, moreover, the parisons are brought to an appropriate temperature immediately after their production by an injection molding technology and after sufficient hardening, and are subsequently inflated.

In regard to the blowing stations used, various embodiments are known. In blowing stations arranged on rotating transport wheels, the mold supports can often be flipped open like a book. However, it is also possible to use mold supports that can be moved relative to one another, or mold supports that are moved differently. In the case of stationary blowing stations, which are particularly suitable for holding several cavities for blow molding a container, plates arranged parallel to each other are typically used as mold supports.

With regard to the sterilization of parisons, different processes and devices are already known from the state of the art; however, they all have process-specific disadvantages that prevent reliably sterilizing the parisons while simultaneously allowing high throughput rates.

For example, in EP-A 1 086 019, the sterilization of hot parisons with a hot gaseous sterilization means is described. Separate processing stations arranged one after the other are used, namely a first heating module, a sterilization module as well as a second heating module. The disadvantage here is the temperature behavior of the parison during the sterilization procedure as well as the uncontrolled exit of the sterilization means from the parison within the heater.

In EP-A 1 896 245, a process is described in which, before the heater, a gaseous sterilization means is introduced into a cold parison and condensed there. The difficulty here is to ensure completion of the condensate formation over the entire inner surface of the parison, since the inflowing hot sterilization means raises the inner wall temperature of the parison. In addition, in this case as well, after the evaporation of the sterilization means in the area of the heater, it escapes uncontrollably from the parison within the heater.

In EP-A 2 138 298, a device is described in which, as a preventive measure, sterilization devices are arranged both before the blowing module used and also after the blowing module used. This results in a quite considerable expense for machine construction.

In WO 2010/020530 A1, the arrangement of a sterilization device between a heater and the blow module is described. In this process, it is difficult to predict the input quantity of sterilization means into the area of the blow module. In addition, the exit quantity of sterilization means released into the environment is uncontrollable and accordingly contamination is not excluded.

After the sterilization and the heating of the parisons, the latter are introduced into a blowing device, wherein they are shaped to the form of the containers using sterile blowing air. According to the known state of the art, the entire area of the blowing device is designed as a sterile space for this purpose. Providing and maintaining a sterile space of such large size require a very high level of expenditure for technical apparatuses. In addition, this spatially large area has numerous potential contamination sites, so that it is exceedingly difficult to ensure sufficient sterility.

The aim of the present invention is to improve a process of the type mentioned at the start in such a manner that a sufficient sterility can be guaranteed in a simple manner.

This aim is achieved according to the invention by carrying out the sterilization at a spatial distance from a blowing station which shapes the parison, and by transporting the parison from the site of the sterilization to the blowing station, at least along a portion of the transport path, along a sterile channel.

A further aim of the present invention is to construct a device of the type mentioned at the start, in such a manner that an effective sterility at low cost is ensured.

This aim is achieved according to the invention in that a sterilization unit which is used to expose the parison to the sterilization means is arranged at a spatial distance from the blowing device, and in that at least a portion of a transport path for the parisons from the sterilization unit to the blowing device extends along a sterile channel.

As a result of the connection of the sterilization unit and the blowing device by a sterile channel, there is no need to provide a spatially extensive sterilization space. In particular, it is no longer necessary to maintain areas which have been contaminated with fat and other operating means sterile in the area of the blowing module which typically comprises a rotating blowing wheel. Rather, it is sufficient to sterilize and keep sterile the area that is in contact with critical areas of the parison or of the blow-molded container. Thus, on the one hand, the expense for sterilization and maintenance of sterilization is considerably reduced, and, on the other hand, the risk of contamination is considerably reduced, since the size of the boundary surfaces between the sterile area and the surrounding area is minimized.

To maintain the sterility of the parisons, it is proposed to expose the parison within the channel to a sterile gas.

In particular, it has been envisaged to lead the sterile gas in the direction of an opening section of the parison.

The access of germs is prevented by the fact that at least a portion of the sterile gas within the channel flows with a propagation component in a longitudinal direction of the channel.

A sterile transfer area for an insertion of the parisons into the blowing device is provided by the fact that the sterile gas flows with a propagation component in the direction of the blowing device.

To support a sterile handling of the finished containers, it is proposed to transport the blow-molded containers after removal from the blowing device in at least some sections and in at least some areas along a sterile channel.

In particular, it has been envisaged to connect the blowing device to a filling device by the sterile channel

Embodiment examples of the invention are represented diagrammatically in the drawings.

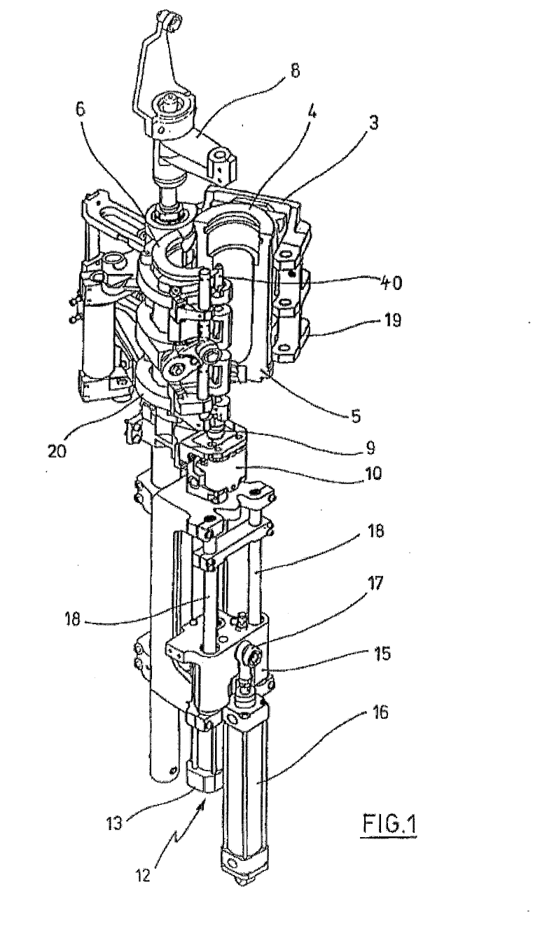

FIG. 1 shows a perspective representation of a blowing station for producing containers from parisons,

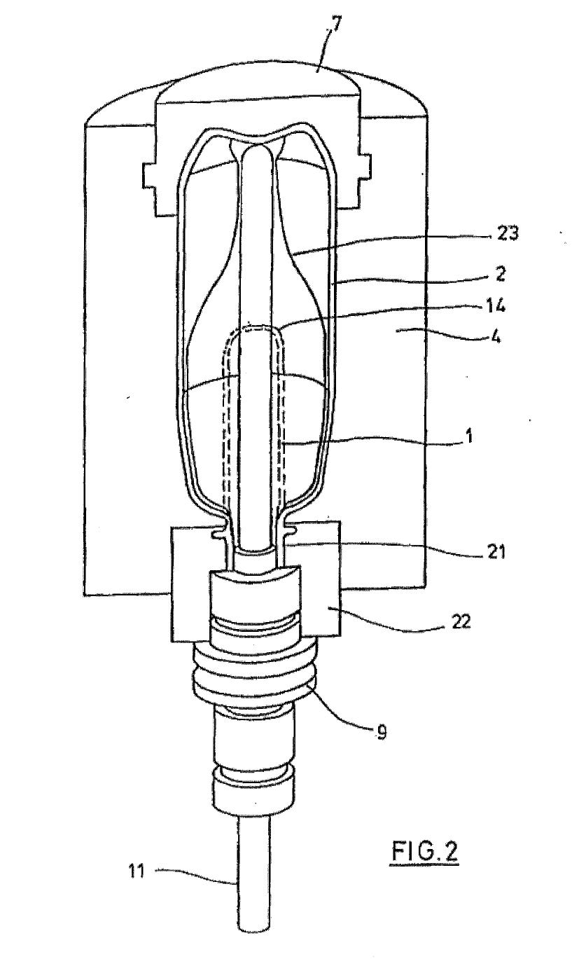

FIG. 2 shows a longitudinal cross section through a blow mold, in which a parison is stretched and expanded,

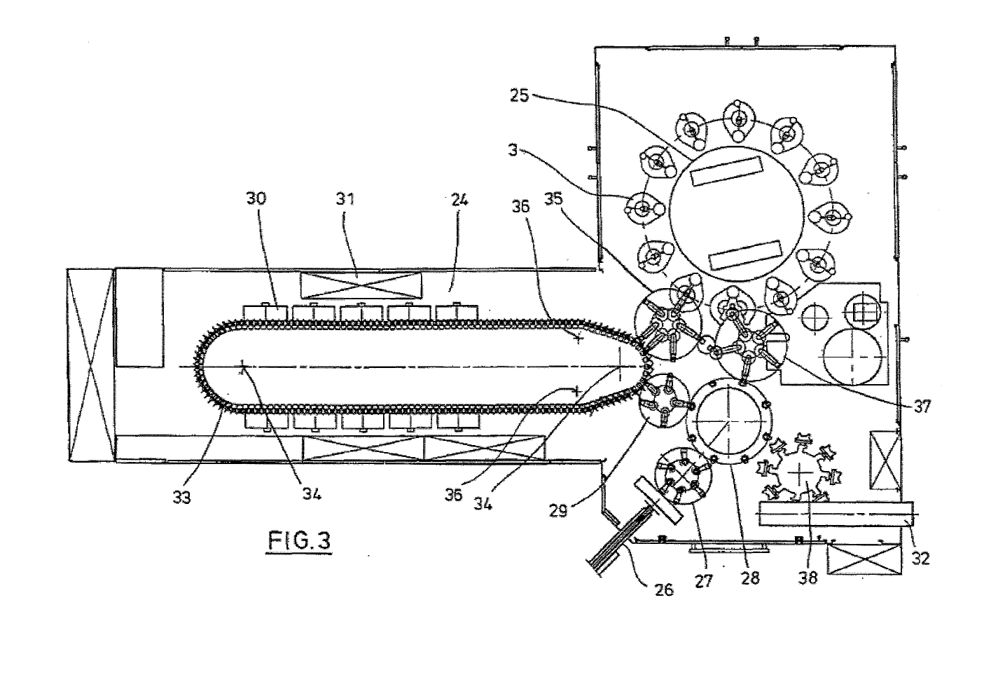

FIG. 3 shows a sketch illustrating a basic design of a device for blow molding containers,

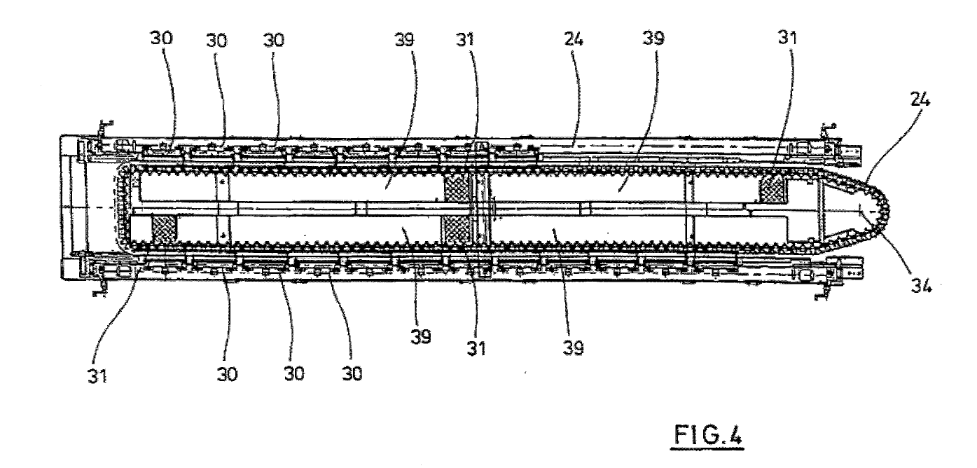

FIG. 4 shows a modified heating section with increased heating capacity,

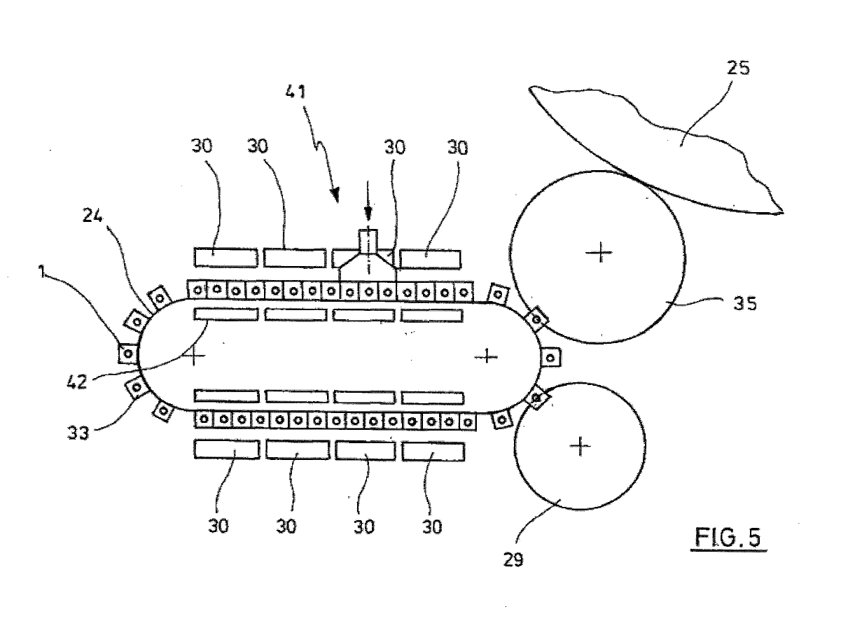

FIG. 5 shows a diagrammatic representation of a heating module of a blowing machine, in which a sterilization device is arranged in the area of the heating module,

FIG. 6 shows a diagrammatic representation for the use of sterile channels for connecting a heating device to a blowing wheel, and the blowing wheel to a discharge section,

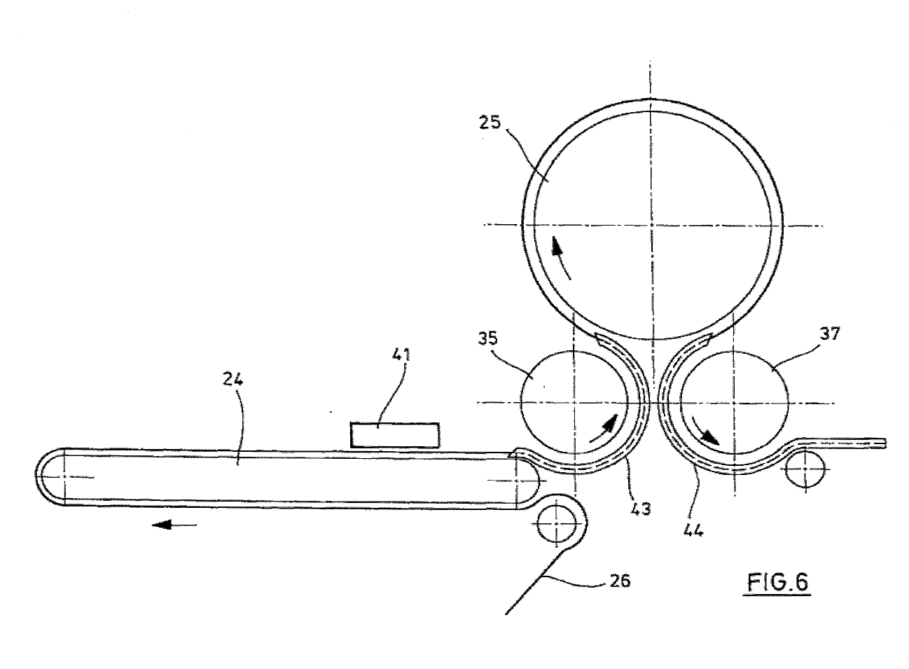

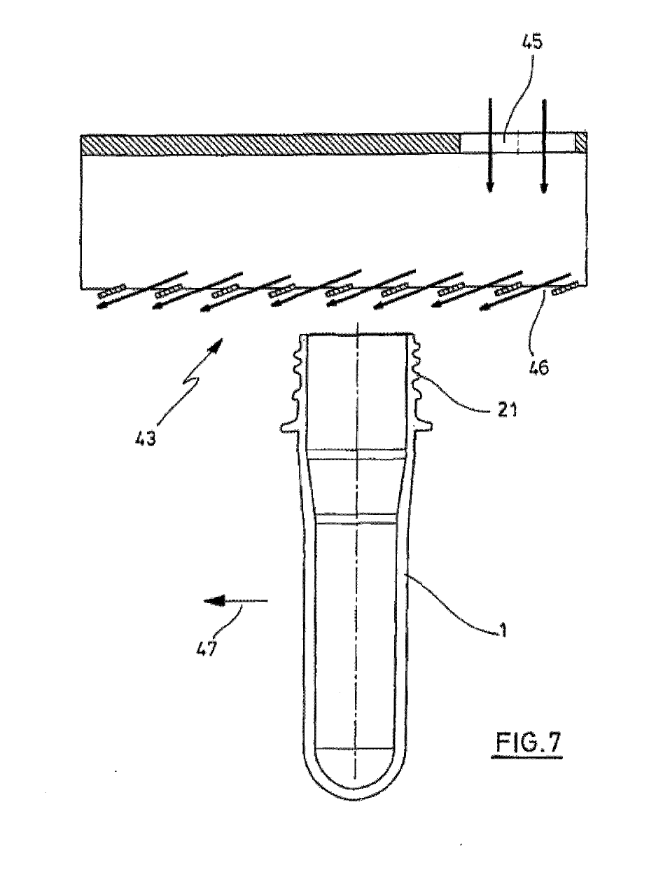

FIG. 7 shows a diagrammatic representation illustrating a feed of sterile gas along a transport section for the parisons,

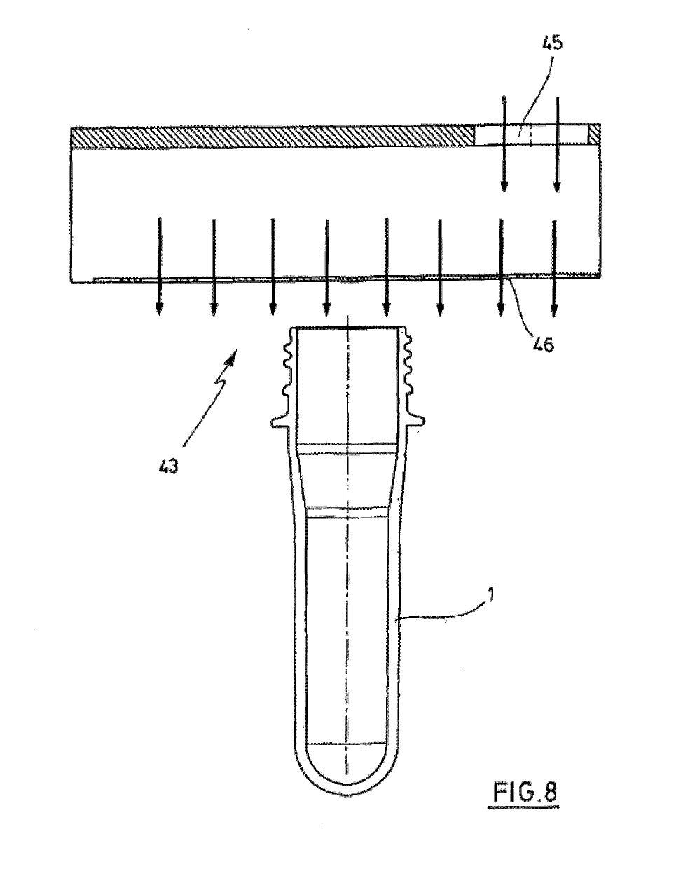

FIG. 8 is an embodiment that is modified in comparison to FIG. 7,

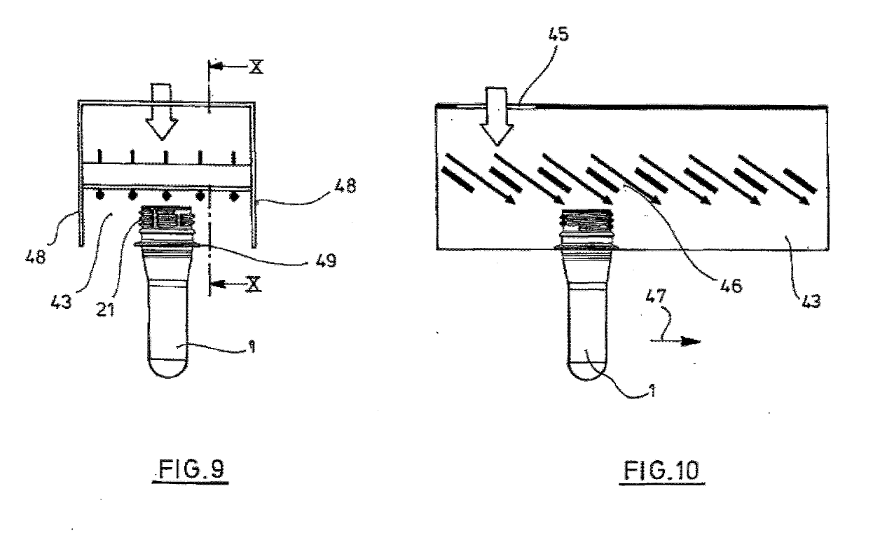

FIG. 9 shows a cross section through a sterile transport area,

FIG. 10 shows a longitudinal cross section along a cutting line X-X in FIG. 9,

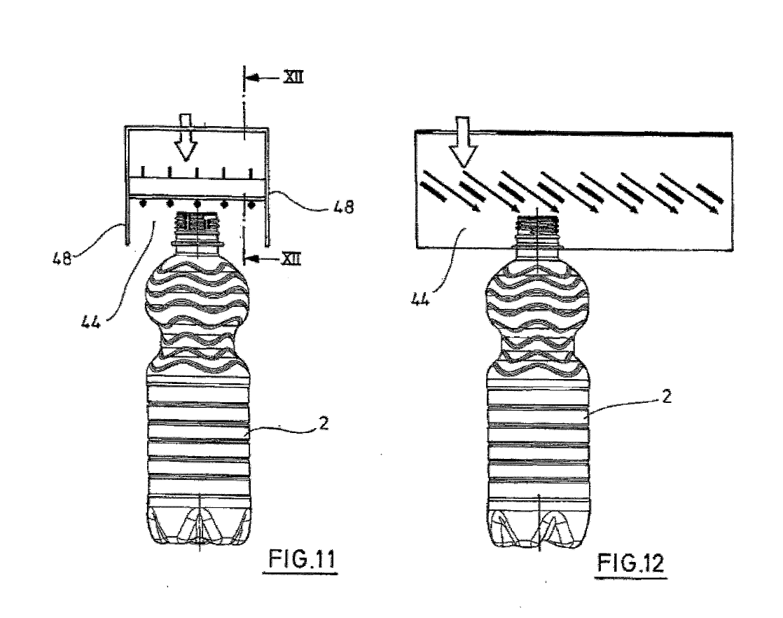

FIG. 11 shows a cross section through a feed of sterile gas in the area of a bottle discharge, and

FIG. 12 shows a longitudinal cross section along a cutting line XII-XII in FIG. 11.

The basic design of a device for shaping parisons (1) into containers (2) is represented in FIG. 1 and in FIG. 2.

The device for shaping the container (2) consists substantially of a blowing station (3) which is provided with a blow mold (4) into which a parison (1) can be inserted. The parison (1) can be an injection molded part made of polyethylene terephthalate. To allow the insertion of the parison (1) into the blow mold (4), and to enable the removal of the finished container (2), the blow mold (4) consists of mold halves (5, 6) and a bottom portion (7) which can be positioned by a lifting device (8). The parison (1) can be retained in the area of the blowing station (3) by a transport mandrel (9), which passes together with the parison (1) through a plurality of processing stations within the device. However, it is also possible to insert the parison (1), for example, using grippers or other handling means directly into the blow mold (4).

To make possible a pressurized air feed, a connection piston (10) is arranged beneath the transport mandrel (9), piston which is used to feed pressurized air to the parison (1) and at the same time ensure sealing relative to the transport mandrel (9). In a modified construction, it is also conceivable in principle to use fixed pressurized air feed lines.

The stretching of the parison (1) is carried out using a stretching bar (11) which is positioned by a cylinder (12). In principle, however, it is also conceivable to carry out a mechanical positioning of the stretching bar (11) via cam sections against which gripping rollers are applied. The use of cam sections is particularly advantageous if a plurality of blowing stations (3) are arranged on a rotating blowing wheel. The use of cylinders (12) is advantageous if blowing stations (3) arranged in a stationary position are provided.

In the embodiment represented in FIG. 1, the stretching system is designed so that a tandem arrangement of two cylinders (12) is provided. The stretching bar (11) is first moved by a primary cylinder (13), prior to the start of the stretching process itself, into the area of a bottom (14) of the parison (1). During the stretching process proper, the primary cylinder (13), with stretching bar extended, is positioned together with a slide (15) supporting the primary cylinder (13) by a secondary cylinder (16) or via a cam control. In particular, it has been envisaged to use the secondary cylinder (16) with cam control so that a current stretching position is predetermined by a guiding roller (17) which slides along a cam path during the performance of the stretching process. The guiding roller (17) is pressed by the secondary cylinder (16) against the guiding path. The slide (15) slides along two guide elements (18).

After closing the mold halves (5, 6) arranged in the area of supports (19, 20), a locking of the supports (19, 20) relative to each other occurs by means of a locking device (40).

For adaptation to different shapes of an opening section (21) of the parison (1), the use of separate threaded inserts (22) in the area of the blow mold (4) is provided according to FIG. 2.

In addition to the blow-molded container (2), FIG. 2 also shows, using dashed lines, the parison (1) and diagrammatically a developing container bubble (23).

FIG. 3 shows the basic design of a blowing machine which is provided with a heating section (24) as well as with a rotating blowing wheel (25). From a parison intake (26), the parisons (1) are transported by transfer wheels (27, 28, 29) into the area of the heating section (24). Along the heating section (24), heating radiators (30) as well as blowers (31) are arranged, for bringing the parisons (1) to the correct temperature. After sufficient adjustment of the parisons (1) to the correct temperature, the latter are transferred to the blowing wheel (25) in whose area the blowing stations (3) are arranged. The containers (2) whose blowing has been completed are fed to a discharge section (32) by additional transfer wheels.

In order to be able to shape a parison (1) to form a container (2) so that the container (2) has material properties that ensure a long usability of food items, particularly beverages that fill the container (2), special process steps have to be implemented in the heating and orientation of the parisons (1). In addition, advantageous effects can be achieved by maintaining special dimensioning specifications.

As thermoplastic material, various plastics can be used. For example, PET, PEN or PP can be used.

The expansion of the parison (1) during the orientation process occurs by the feeding of pressurized air. The feeding of pressurized air is subdivided into a preliminary blowing phase in which the gas, for example, pressurized air, is fed at a low pressure level, and a subsequent main blowing phase in which the gas is fed at a higher pressure level. During the preliminary blowing phase, pressurized air at a pressure in the range from 10 bar to 25 bar is typically used, and during the main blowing phase, pressurized air at a pressure in the range from 25 bar to 40 bar is fed.

From FIG. 3, one can also see that, in the represented embodiment, the heating section (24) is formed from a plurality of circumferential transport elements (33) which are arranged in a chain-like pattern next to one another and guided along deflection wheels (34). In particular, it has been envisaged to delimit by means of the chain-like arrangement a substantially rectangular basic contour. In the represented embodiment, in the area of the extent of the heating section (24) which faces the transfer wheel (29) and an input wheel (35), a single relatively large-size deflection wheel (34) is used, and in the area of adjacent deflections, two comparatively smaller sized deflection wheels (36) are used. However, in principle it is also conceivable to use any other guides.

To enable the most compact arrangement of the transfer wheel (29) and of the input wheel (35) relative to each other, the represented arrangement has been found to be particularly appropriate, since three deflection wheels (34, 36) are positioned in the area of the corresponding extent of the heating section (24); in particular, in each case, the smaller deflection wheels (36) are positioned in the area of transition to the linear courses of the heating section (24), and the larger deflection wheel (34) is positioned in the immediate transfer area leading to the transfer wheel (29) and to the input wheel (35). Alternatively to the use of chain-like transport elements (33), it is also possible, for example, to use a rotating heating wheel.

After completion of the blowing of the containers (2), the latter are removed by a removal wheel (37) from the area of the blowing stations (3), and transported via the transfer wheel (28) and a discharge wheel (38) to the discharge section (32).

In the modified heating section (24) represented in FIG. 4, due to the larger number of heating radiators (30), a larger quantity of parisons (1) can be brought to the correct temperature per unit of time. The blowers (31) here lead cooling air into the area of the cooling air channels (39) which in each case face the associated heating radiators (30), and discharge the cooling air through the outflow openings Due to the arrangement of the outflow directions, a flow direction for the cooling air is produced that is substantially transverse to a transport direction of the parisons (1). In the area of surfaces facing the heating radiators (30), the cooling air channels (39) can provide reflectors for the heating radiation; it is also possible to produce a cooling of the heating radiators (30) by means of the discharged cooling air.

FIG. 5 shows diagrammatically and in a highly simplified manner an arrangement similar to the representation in FIG. 3 with the additional arrangement of a sterilization device (41) in the area of the heating section (24). Also included in the drawing are the transport elements (33) of the heating section (24).

The sterilization means is introduced preferably in a gaseous state into the parison (1). In particular, it has been envisaged to use a temperature of the sterilization means above 100° C.

Advantageously, the parison (1) is at a temperature of more than 80° C. during the performance of the sterilization process in the area of its inner surface to be sterilized. With regard to the sterilization means, the possibility of using hydrogen peroxide is envisaged in particular.

FIG. 5 illustrates the arrangement of the parison (1) during the performance of the sterilization process in the heating section (24). The parison (1) is exposed here both to the sterilization means and also to heating radiators (30). The exposure of the parison (1) to the sterilization means occurs preferably in the area of the inner surface of the parison (1), and the exposure to the heating radiation occurs preferably in the area of an outer surface. In the represented embodiment example, the heating radiators (30) are arranged on one side along a transport direction of the parisons (1) through the heating section (24). Opposite the heating radiators (30), the reflectors (42) are positioned. Typically, the heating radiators (30) are arranged in the area of heater boxes, wherein reflectors held by the heating box are arranged on a side of the heating radiators (30) which faces away from the parisons (1). It is preferable for the reflectors to have a reflection profile. Between the heating radiators (30) and the parisons (1), a filter disk which has frequency-selective properties can be positioned. The filter disk can be made of quartz glass, for example.

The heating radiators (30) preferably generate a heating radiation in the NIR range. However, it is also possible to use infrared radiators, light emitting diodes or radiation devices for microwave energy or high-frequency energy.

Optionally, a combination of two or more of the above-mentioned heat sources is also possible.

According to typical process conditions, the sterilization means is at a temperature in the range from 100° C. to 130° C. during the performance of the sterilization. During the performance of the sterilization, the parison (1) is at a temperature of 100° C. to 130° C. at least in the area of its inner surface. A typical sterilization duration is approximately 0.1-0.5 s. As sterilization means, it is preferred to use evaporated hydrogen peroxide which is mixed with hot air. The hydrogen peroxide concentration here is approximately 15-35 wt %.

FIG. 6 shows a diagrammatic representation similar to the representation in FIG. 3, but highly diagrammatic. The parisons (1) are heated here in the area of the heating section (24), and sterilized by the sterilization device (41). The heating section (24) is designed as a sterile area at least in the corresponding transport direction of the parisons (1), between the sterilization device (41) and the input wheel (35). Starting from the end of the sterilization device (41) or of the sterilization area of the heating section (24), a channel (43) extends in the direction of the blowing wheel (25). The channel (43) is used to surround the parison (1) at least in some sections with a sterile gas so that a contamination of the parison (1) with germs along the transport path is ruled out. In the area of the blowing wheel (25), the parison (1) is inserted into a blowing station (3). In this case as well, a sufficiently sterile handling of the parison (1) is ensured.

As soon as the parison (1) has been fastened in the input area of the heater (24) by the associated transport element, it has been envisaged in particular to introduce a fastening element into the opening section of the parison (1), fastening element which seals an inner space of the parison (1) with respect to the surroundings and as a result provides protection against contamination with germs from the ambient air. The corresponding sealing element can also be designed as a transport element for the parison (1). In particular, it has been envisaged to introduce the sterilization means through the sealing element into the inner space of the parison (1). Said sterilization means is preferably a mixture of hydrogen peroxide and air. After leaving the sterilization device (41), the inner space of the parison (1) is still sealed from the surroundings by the fastening element, and protected against contamination.

It is only after the fastening element and the parison (1) have been separated from each other that the inner space of the parison (1) becomes accessible to contamination originating from the ambient air. The positioning of the channel (43) preferably occurs starting from the time of this separation of the fastening element and the parison (1).

A discharge area of the blowing wheel (25) is also provided at least along the removal wheel (37) with a channel (44) which, similarly to the channel (43), provides a clean space of sufficient dimension, through which in this case the blown containers (2) are transported, in at least in some areas.

In a cross-sectional representation, FIG. 7 shows a parison (1) which is led along the channel (43). The channel (43) has a feed opening (45) for a sterile gas, and a plurality of outflow openings (46). In the represented embodiment, the outflow openings (46) are arranged transversely to a vertical direction. This leads to a propagation component of the sterile gas flowing out of the channel (43) in a transport direction (47) of the parisons (1). As a result, a flow of the sterile gas in the direction of an input area of the blowing wheel (25) is generated, so that an insertion of the parisons (1) into the blowing station (3) in a sterile environment is supported.

The sterile gas flows out of the channel (43) in such a manner that at least the opening section (21) of the parison (1) is positioned within the sterile gas, so that the access of germs is prevented.

FIG. 8 shows an embodiment in which the sterile gas flows substantially in a vertical direction out of the channel (43). In particular, the possibility of providing a laminar flow has been envisaged. The entrainment of non-sterile ambient air is consequently prevented.

FIG. 9 shows a construction that is modified compared to the embodiment in FIG. 7. Here, additional side walls (48) are used, which delimit to the side the area of the channel (43) surrounding the opening section (21). As a result, the flow guidance of the sterile gas is supported. According to an additional embodiment not shown in the drawing, the channel (43) is also delimited in the vertical direction downward by a wall so that the opening section (21) is led within this delimited area. As a result, on the one hand, the guidance of the sterile gas is again supported, and, on the other hand, the flow of sterile gas in an area of the parison (1) beneath a supporting ring (49) is also reduced. The corresponding delimitation of the channel (43) extends here, for example, in the direction of the supporting ring (49), or it ends beneath the supporting ring (49).

FIG. 10 again illustrates the flow guidance of the sterile gas within the channel (43). FIG. 11 and FIG. 12 illustrate the construction of the channel (44) by providing a locally delimited sterile environment for the blow molded containers (2). The construction of the channel (44) is here substantially the same as the construction of the channel (43). Like the channel (43), the channel (44) can be provided optionally with one or two side walls (48), or, in addition, it can also be delimited by walls completely or in some sections in a vertical direction downward.

The channel (44) extends preferably starting from the blowing wheel (25) into the area of a filling device for filling the containers (2) with a product. As a result, a sufficiently sterile environment is provided for the entire transport area of the container (2).

In the area of the blowing stations (3), it is preferable to maintain sterile only those areas that come in contact with the opening section (21) or with an inner space of the parison (1) or of the container (2). With regard to the additional areas of the parison (1) or of the container (2), on the other hand, no special sterility requirements are specified. Due to this sterility that is locally delimited in some places, one takes into consideration that, after filling the containers (2) with the filling product, by means of an appropriate closing device the filled inner space of the container (2) is delimited in a sterile manner from an environment. Any germs that may adhere to an outer surface can thus not penetrate into the area of the filled product.

The parisons (1) or the containers (2) can thus be transported either along a channel (43, 44) from which the sterile gas flows in the direction of the parisons (1) or the containers (2), or the parisons (1) or the containers (2) can be transported all or partially within the sterile channel (43, 44).

1. A method for producing blow-molded containers, at least some areas of which are sterile, wherein a parison made of a thermoplastic material is first heated and then exposed to a pressurized fluid, and wherein a sterilization means is fed into an area of the parison, wherein sterilization is carried out at a sterilization site a spatial distance away from a blowing station which shapes the parison, and in that wherein instead of maintaining the entire area of the blowing device as a sterile space the parison is transported from the sterilization site to the blowing station, at least along a portion of a transport path, along a sterile channel.

2. The method according to claim 1, wherein the parison is exposed to a sterile gas within the channel.

3. The method according to or claim 2, wherein the sterile gas is led in a direction of an opening section of the parison.

4. The method according to one of claim 2, wherein at least a portion of the sterile gas within the channel flows with a propagation component in a longitudinal direction of the channel.

5. The method according to claim 4, wherein the sterile gas flows with the propagation component in the direction of the blowing device.

6. The method according to claim 1, wherein the blow-molded containers, after removal from the blowing device, are transported at least in some sections and at least in some areas along a sterile channel.

7. The method according to claim 6, wherein the blowing device is connected to a filling device by the sterile channel.

8. A device for producing blow-molded containers that are sterile at least in some areas, the device comprising a feed device for exposing at least a portion of a parison to a sterilization means, said device being provided with a heating section for bringing the parisons to the correct temperature, and with a blowing device for blow molding the parisons to form the containers, wherein a sterilization device which exposes the parison to the sterilization means is arranged at a spatial distance from the blowing device, and wherein at least a portion of a transport path for the parisons extends from the sterilization device to the blowing device along a sterile channel.

9. The device according to claim 8, wherein the channel comprises a connection for feeding a sterile gas.

10. The device according to claim 8, wherein the channel comprises an outflow opening for discharging the sterile gas in a direction of an opening section of the parison.

11. The device according to claim 10, wherein the outflow opening is oriented in such a manner that the sterile gas flows with a propagation component in a longitudinal direction of the channel.

12. The device according to claim 11, wherein the outflow opening is oriented in such a manner that sterile gas flows with a propagation component in the a direction of the blowing device.

13. The device according to claim 8, wherein an additional sterile channel is arranged in a transport direction of the containers after the blowing device.

14. The device according to claim 13, wherein the channel connects the blowing device to a filling device.
